(19) United States
(12) Patent Application Publication
(10) Pub. No.: US 2004/0015384 A1
(43) Pub. Date: Jan. 22, 2004

(54) System and method for facilitating communication design

(76) Inventor: Edward F. Lupo, Germantown, TN (US)

Correspondence Address: SHAW PITTMAN, IP GROUP, 1650 TYSONS BOULEVARD, SUITE 1300, MCLEAN, VA, 22102, US

(21) Appl. No.: 10/457,468

(22) Filed: Jun. 10, 2003

Related U.S. Application Data
(60) Provisional application No. 60/386,737, filed on Jun. 10, 2002.
(60) Provisional application No. 60/387,408, filed on Jun. 11, 2002.

(51) Int. Cl. G06F 17/60

(52) U.S. Cl. 705/8; 705/27

(57) ABSTRACT

The present invention relates generally to a system for facilitating communication design comprising a web application configured to receive rules governing the design of a communication, the rules being promulgated by a first business organization. The web application may permit interaction by a second business organization that is different than the first business organization, wherein the web application permits the second business organization to select a predefined template and populate the predefined template with content to design the communication. The web application may apply the rules to ensure that the communication conforms to the rules. The system further may receive delivery instructions from the second business organization and deliver the communication to a destination selected by the second business organization.

This application claims the benefit of U.S. Provisional Application Nos. 60/386,737, filed Jun. 10, 2002 and 60/387,408, filed Jun. 11, 2002, which are herein incorporated by reference in their entirety.

### BACKGROUND

1. Field of the Invention

The present invention relates generally to an internet application, and more particularly, to a system and method for facilitating communication design.

2. Background of the Invention

In the advertising industry, companies often produce advertisements for regional or national circulation to promote their products or services. In many industries, local entities operate under the umbrella of large corporations to service individual locations. For example, automobile dealerships often sell one or more manufacturer's automobiles, but are individually owned and operated. Each of these local entities may desire to advertise in a manner most suitable to its geographic location and customer preferences.

These large parent corporations, however, often desire a level of control over their local representatives to ensure, among other things, the reputation associated with their corporate name and/or products and services. Such an approval process can be both costly and time consuming. Traditionally, a parent organization may be required to receive samples of all proposed advertising material in hard copy in order to grant approval. In addition, smaller local representatives may not have the financial capability to produce a level of quality advertisement suitable for approval. Accordingly, a low-cost, time saving, controllable solution would be desirable to both local users and corporate parent organizations.

### BRIEF SUMMARY OF THE INVENTION

The present invention relates generally to a system for facilitating communication design comprising a web application configured to receive rules governing the design of a communication, the rules being promulgated by a first business organization. The web application may permit interaction by a second business organization that is different than the first business organization, wherein the web application permits the second business organization to select a predefined template and populate the predefined template with content to design the communication. The web application may apply the rules to ensure that the communication conforms to the rules. The system further may receive delivery instructions from the second business organization and deliver the communication to a destination selected by the second business organization.

According to another aspect, a method of facilitating communication design for receiving rules governing the design of a communication is disclosed, the rules being promulgated by a first business organization. Interaction by a second business organization that is different than the first business organization permits the second business organization to select a predefined template and populate the predefined template with content to design the communication. The rules may be applied to ensure that the communication conforms to the rules. Further, delivery instructions may be received from the second business organization and for delivering the communication to a destination selected by the second business organization.

### BRIEF DESCRIPTION OF THE DRAWINGS

FIG. 1 is a schematic diagram of a preferred embodiment of a system in accordance with the present invention;

FIG. 2 is a flow diagram of a preferred embodiment of a method in accordance with the present invention;

FIG. 3 is a schematic diagram of a preferred embodiment of a template in accordance with the present invention;

FIG. 3a is a schematic diagram of a preferred embodiment of a template in accordance with the present invention including a coupon block; and

FIG. 4 is a flow diagram of an exemplary method for creating communication documents in accordance with an embodiment of the present invention.

### DISCLOSURE OF PREFERRED EMBODIMENTS OF THE INVENTION

Features and advantages of the invention will be set forth in the description which follows, and in part will be apparent from the description, or may be learned by practice of the invention. The objectives and advantages of the invention will be realized and attained by the structure and steps particularly pointed out in the written description, the claims and the drawings.

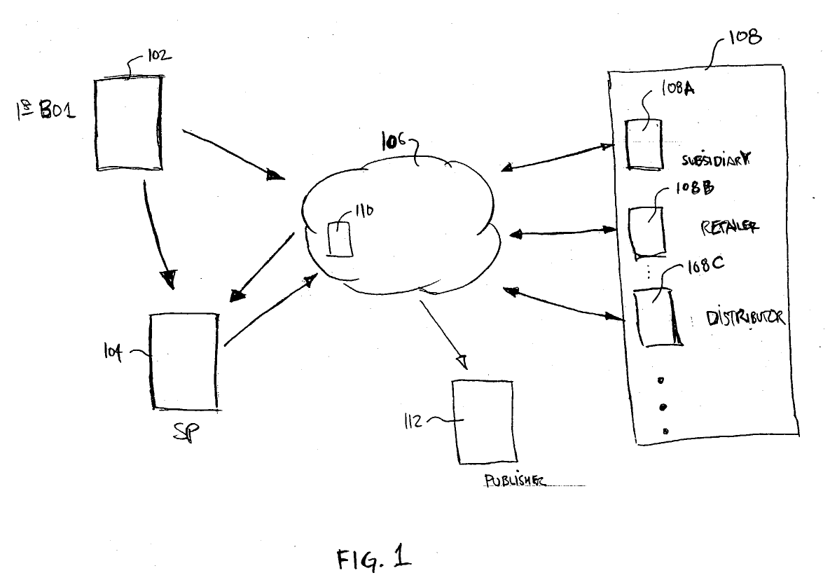

Referring to FIG. 1, the process begins with a first business organization 102 sending rules to a service provider 104. Rules include information related to appropriate or approved formats for communications related to business organization 102. Additional information related to these rules is disclosed below. Service provider 104 uses the information to prepare and/or populate a web-based application 110. The web-based application 110 is configured for use and interaction on internet 106. Second business organizations 108 interact with the web-based application 110 through the internet 106. Second business organizations 108 can be, for example, subsidiaries, branch offices, retailers, distributors or any other business organization that is different than first business organization 102 but, in some way, produces or authorizes content that relates to a product or service offered by first business organization 102.

One example is where second business organization 108C is a distributor or retailer that sells a product produced by the first business organization 102. In this example, first business organization 102 conducts business with certain distributors 108C that are located in certain geographic locations, and first business organization 102 has given the responsibility to locally advertise its products to those distributors 108C.

Another example of a second business organization 108B is a retailer that advertises products offered by first business organization 102 in local newspapers or other local media outlets.

Regardless of the exact nature or relationship of second business organization 108, second business organization 108 preferably interacts through internet 106 with application 110. Application 110 is maintained and made available on the internet 106 to authorized users by service provider 104.

Second business organizations 108 interact with application 110 in many different ways to produce or send desired content. Second business organizations 108 can provide information to application 110 to select various layouts or formats for the content and then to select different items or assets that populate the layout or format and form portions of the communication.

There are many different delivery options. The communication can be made available to second business organizations 108 to download from application 110 or another internet resource. The communication can also be sent to second business organization 108 by e-mail. As another alternative, the communication can be sent to another party, for example, a publisher 112 that will eventually print, publish or distribute the communication. To continue the example of the distributor 108C, the communication can be an advertisement designed by the distributor 108C, and publisher 112 could be a local newspaper or magazine that has agreed to carry the advertisement.

Service provider 104 can also monitor, receive feedback, and/or track the usage of application 110, and can collect data. In some embodiments, the conduct of second business organizations 108 can be tracked. For example, service provider 104 can track any action taken by any of the second business organizations 108 as they are interacting with application 110. For example, as second business organizations 108 design a particular communication, all of their conduct and behavior can be monitored and collected by service provider 104.

One example of this monitoring function is the situation where a particular second business organization 108A is selling many more items than any of the other second business organizations 108. First business organization 102 wants to investigate whether the communications generated by second business organization 108A are causing the commercial success. To investigate this possibility, service provider 104 can retrieve information related to the communications generated by second business organization 108A. Preferably, application 110 includes monitoring and tracking features that permit the capture of all information sent to it by second business organizations 108. This information can be retrieved and either analyzed by service provider 104 or the information can be sent to first business organization 102.

In another embodiment, service provider 104 provides access to this information to first business organization 102 so that first business organization 102 can directly access application 110 and retrieve monitoring and tracking information.

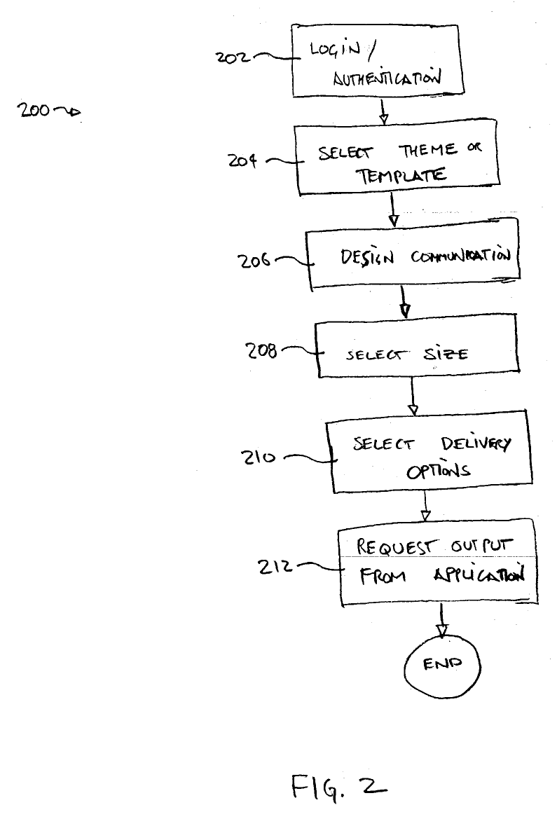

FIG. 2 shows a schematic diagram of a preferred embodiment of a method 200 for interacting between a second business organization 108 (see FIG. 1) and web application 110 (see FIG. 1). The interaction preferably begins with a login or authentication step 202. In this step, web application 110 verifies the identity of the user and/or business organization that is attempting an interaction. This login step 202 can include the receipt of a password, a user identification or other indicia that web application 110 knows and that is also associated with second business organizations 108.

After the login process 202 has been completed, the user can select a theme or template in step 204. In this step, users are preferably given a variety of options and are able to select a general theme or template that represents an organizational style or design of data, elements, graphics, text and other types of content.

As used herein, the term “template” refers to a set of instructions that execute as a program on a web application server. For example, a template is a program of web application 110 that automates the construction of communications documents based on query results and user input.

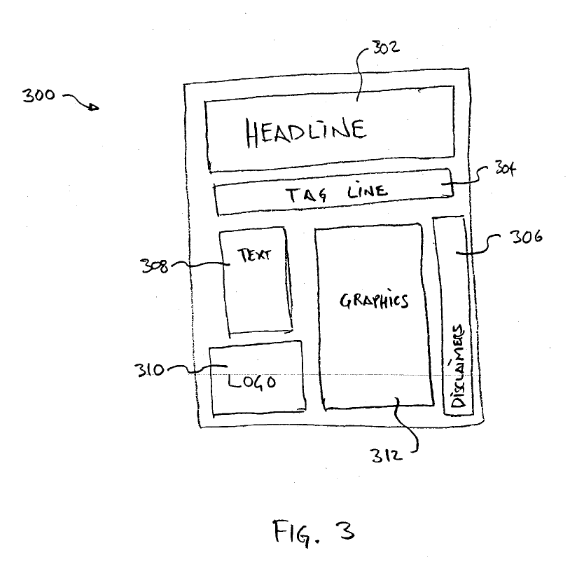

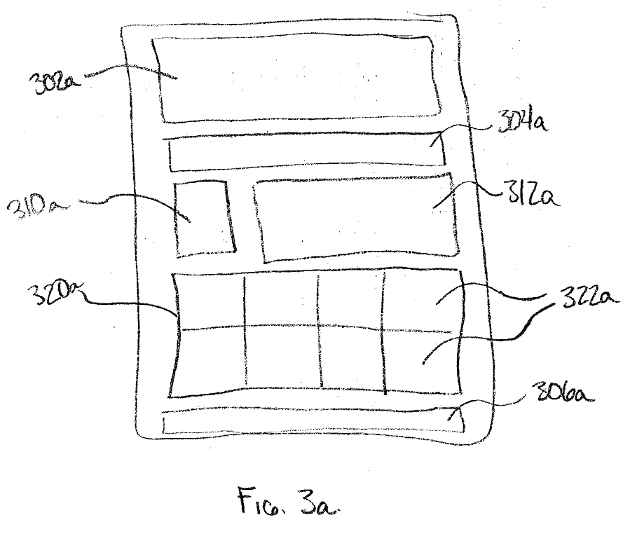

FIG. 3 shows an example of a theme or template 300, which includes a headline area 302, a tag line area 304, a disclaimer area 306, a text area 308, a logo area 310, and a graphics area 312. All elements of template 300 (along with a unique identification, or ID, number) are recorded in a database of service provider 104, which is referred to herein as a composition table. The composition table may also contain information about the user of the site (e.g., based on login parameters), information that the user has submitted with web forms and/or links, and any other data that can be looked up or received, which is related to the communication document or which might be useful to collect over a period of time. The invention stores composition tables that specify the elements that are included in template 300 to create a document. Thus, rather than storing finished documents on the server(s) of service provider 104, which would likely include multiple copies of the same elements, the present invention stores one copy of each possible element and uses the composition tables to dynamically generate the documents on the server(s) of the second business organizations 108 or publisher 112. The query results of the composition table are delivered to second business organizations 108 or third party publisher 112, and used to construct the final document on the computer of the second business organizations 108 or third party publisher 112.

Referring again to FIG. 2, after a particular theme or template has been selected, users can then design their particular communication in step 206. Users can design their communication by selecting desired data, elements, graphics, text and other forms of content that can be used to populate the template selected in step 204. Preferably, web application 110 (see FIG. 1) has been programmed with rules for the design. For example, if a particular headline is selected, a rule may not permit users to select certain graphics for use with that headline. These rules can function in many different ways to ensure that the user eventually creates a communication that would be approved by first business organization 102 (see FIG. 1). In some embodiments, the rules can gray out elements and/or content that is not permitted for use with existing, previously selected elements.

In step 208, users select a particular size for the communication. In one embodiment, in which web application 1 10 is used to generate advertising communications, web application 110 is used to generate advertisements for newspapers and magazines. Those periodicals require advertisements to be of a certain size and shape. In this embodiment, web application 110 can be programmed to know and understand those size and shape requirements, and those various sizes can be selected by the user for the communication that was designed in step 206.

Once the appropriate size has been selected, web application 110 retrieves an original file and converts it into the desired size. This scaling process can be accomplished in many different ways. For example, when any particular template has been selected, web application 110 analyzes the original intended size of the document and compares that original size against the new intended size to formulate a conversion factor. The conversion factor is not used to simply enlarge a document (because no completed document exists on web application 110 or a server of service provider 104), but to construct a document element by element at the correct size using the conversion factor. The conversion factor is programmatically applied to every unit of measurement in a template and is included in the composition table.

After the size has been selected, users can have their work delivered in many different ways in step 210. Users can choose various options such as e-mail delivery, downloading from the web, or sending the design to a third party. If the third option is selected, users often request delivery to the party that is going to eventually publish the communication. In some cases, a publisher 112 (see FIG. 1) is selected. Publisher 112 can either receive the finished communication or receive a message that a communication has been completed with instructions for retrieving the communication.

This system may also be used to generate communications such as advertising flyers with, for example, coupons for good, services, or the like. For example, as seen in FIG. 3a, a typical advertising flyer 300a containing information similar to that in flyer 300, such as a headline 302a, a tag line 304a, a disclaimer 306a, a logo 310a, and graphics 312a, as well as coupon block 320a is shown. The system according to the present invention allows first business organization 102 to issue rules specifying various offers or deals that may be advertised by second business organizations 108.

Second business organization 108 would have the capability to further modify coupon block 320a so that it may select coupons it believes will be most successful for its particular region. Second business organizations 108 could also possibly modify individual coupons 322a if the rules of the system so allowed. Modification of the individual text of the offers contained in coupons 322a would allow organizations 108 to customize, for example, prices according to its geographic location. The system may also be designed to establish rules governing such prices based on geographical information associated with a particular organization 108. Coupon block 320a may also be any other modular block of information containing further modifiable sections 322a and is not limited solely to coupons.

In step 212, users request output from web application 110. In this step, web application 1 10 delivers the desired design in the manner selected in step 210. In this step, web application 110 uses all of the choices selected by the user in the previous steps and begins to assemble a message with instructions.

In a preferred embodiment, the actual communication is not previously assembled or created by web application 110. In other words, web application 110 does not actually create the communication; rather, web application 110 preferably only shows a preview of the communication. Once a user requests delivery, then web application 110 sends a message with instructions. Preferably, these instructions are given in a language that can be interpreted by a generic web browser or other universal local application.

The instructions provide detailed information on the actual, literal construction of the communication that enables the local computer to compose the communication. For example, the instructions include the size, location, font, scale and other attributes of various items and content sent to the local computer. All of these elements can be assembled by the local computer to generate the communication designed by the user in the previous steps. In this way, web application 110 can quickly deliver a complete and finished communication to the desired recipient. In addition, by storing single copies of elements and using composition tables to dynamically generate communications on the computers of second business organizations 108 or publisher 112, the invention avoids storing multiple, large files of completed communication documents on the server(s) of service provider 104.

As an example of this dynamic generation of communication documents, web application 110 issues a query against the composition table before any other piece of code runs. After the query results are returned, web application 110 begins to set up parameters for the document type it is about to describe. Query results are used to initialize any graphic elements used in the communication (e.g., photographs, logos, and illustrations). Web application 110 is then ready to execute the document's construction. Once the page has been described, web application 110 purges the service provider 104's server of all variables held in memory and closes the document type.

The use of the composition tables in the present invention provides significant benefits. Because web application 110, through the use of the composition table, instructs the end user's browser to construct the communication document, there is no .pdf file to deliver or store. Indeed, rather than storing a finished document on a server of service provider 104, the present invention instead enters a composition record of all of the elements used to compose the document into a composition table.

With a composition table, the present invention makes it very convenient for a user to send an ad to someone else (e.g., pre-press shop, publication, or printer). Because the user is only sending a URL address with a composition record ID appended to it, the file is very small and quickly transmitted.

The composition table is also used to evaluate site usage as logs. And, again, because the present invention only stores data about the ad (and not the complete document itself), the present invention can store composition records for every advertisement, built by every user at virtually no cost to resources of the server(s) of service provider 104.

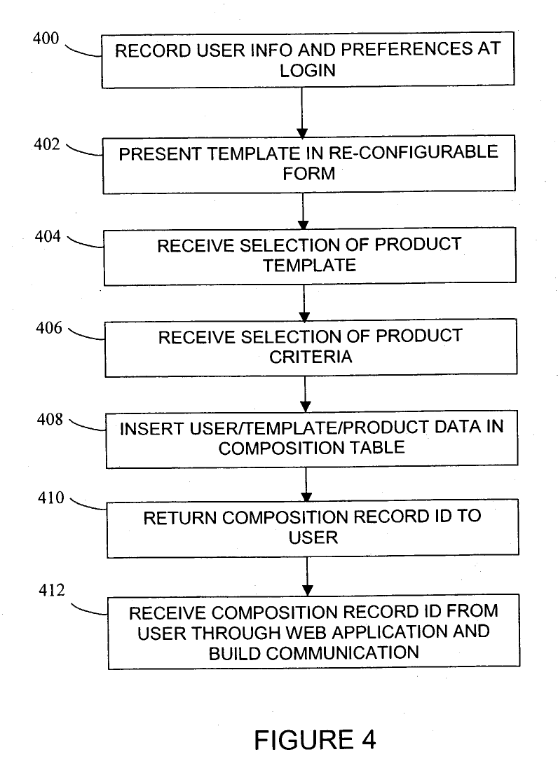

As a further illustration of the use of composition tables, according to another embodiment, the present invention provides a system and method for creating customized advertising documents, using predefined corporate assets assembled in accordance with established business rules and policies for maintaining brand integrity. FIG. 4 provides an overview of an exemplary method for creating the advertising documents.

As shown in step 400, when a login request is received, user personal information and preferences are recorded. In step 402, a series of templates from which to choose are presented. The templates are presented in re-configurable form. A selection of a product template is then received in step 404. In step 406, product criteria are received. Throughout the process of receiving product criteria, the options an end user is presented with vary, based on the implementation of the corporate business rules. When final sections are made and all requirements are filled, in step 408, any data received or looked up about the advertisement is used to populate a composition table. When the composition table is populated, the record is assigned a unique identification (ID) number, or record ID, which is immediately returned to the end user in step 410. The user is directed to a web application and is asked to provide the composition record ID in step 412. The query results on the composition table are used to construct the document, as described above.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for facilitating communication design comprising:
a web application configured to receive rules governing the design of a communication, the rules being promulgated by a first business organization;
the web application permitting interaction by a second business organization that is different than the first business organization, wherein the web application permits the second business organization to select a predefined template and populate the predefined template with content to design the communication;
the web application applying the rules to ensure that the communication conforms to the rules;
receiving delivery instructions from the second business organization; and
delivering the communication to a destination selected by the second business organization.

2. The system according to claim 1, wherein the web application removes as options selections that would violate the rules.

3. The system according to claim 1, wherein delivering comprises at least one of delivery by e-mail, downloading, and sending the communication to a third party.

4. The system according to claim 3, wherein the third party comprises a publisher.

5. The system according to claim 1, wherein the web application permits tracking of the second business organization's activity by the first business organization.

6. The system according to claim 1, wherein the communication is stored at the location of the web application as a composition table.

7. The system according to claim 6, wherein the template comprises a plurality of elements.

8. The system according to claim 7, wherein the plurality of elements comprises at least one of a headline, a tag line, a disclaimer, user-selected text, a logo, and graphics.

9. The system according to claim 8, wherein the delivering comprises delivery of the composition table and at least one of the plurality of elements and the communication is dynamically generated at the destination.

10. The system according to claim 9, wherein the delivering further comprises delivery of instructions to facilitate the communication being dynamically generated.

11. The system according to claim 1, wherein the second business organization is required to login to the system.

12. The system according to claim 10, wherein the login requires entry of a valid password.

13. The system according to claim 1, wherein the second business organization selects a particular size for the communication.

14. The system according to claim 13, wherein the communication is sized by applying a conversion factor to size elements contained in the communication separately.

15. The system according to claim 13, wherein the communication is sized according to a predetermined size suitable for publication.

16. The system according to claim 6, further comprising associating an identification number to the composition table.

17. The system according to claim 16, wherein one of the second business organization and a third party accesses a desired composition table by inputting the identification number of the desired composition table.

18. The system according to claim 7, wherein at least one of the plurality of elements comprises a coupon block.

19. The system according to claim 18, wherein the coupon block is divided into a plurality of separately modifiable sections.

20. A method for facilitating communication design comprising:
receiving rules governing the design of a communication, the rules being promulgated by a first business organization;
permitting a second business organization that is different than the first business organization, to select a predefined template and populate the predefined template with content to design the communication;
applying the rules to ensure that the communication conforms to the rules;
receiving delivery instructions from the second business organization; and
delivering the communication to a destination selected by the second business organization.

21. The method according to claim 20, further comprising removing as options selections that would violate the rules.

22. The method according to claim 20, wherein delivering comprises at least one of delivery by e-mail, downloading, and sending the communication to a third party.

23. The method according to claim 20, further comprising informing the first business organization of the second business organization's activity.

24. The method according to claim 20, wherein the second business organization selects from a plurality of elements comprising at least one of a headline, a tag line, a disclaimer, user-selected text, a logo, and graphics.

25. The method according to claim 20, wherein the second business organization selects a particular size for the communication.

26. The method according to claim 25, wherein the communication is sized by applying a conversion factor to size elements contained in the communication separately.

27. The method according to claim 25, wherein the communication is sized according to a predetermined size suitable for publication.
